(19) United States
(12) Patent Application Publication
(10) Pub. No.: US 2010/0070584 A1
(43) Pub. Date: Mar. 18, 2010

(54) METHOD AND SYSTEM FOR DYNAMIC E-MAIL VIEW CONVERSION

(75) Inventors: Danny Yen-Fu Chen, Austin, TX (US); Ta-Wei Lin, Taipei (TW); Chih-Wen Su, Taipei (TW); Meng Li Wong, Taipei (TW)

Correspondence Address: IBM Corporation (Endicott);c/o Ortiz & Lopez, P.O. Box 4484, Albuquerque, NM, 87196-4484, US

(73) Assignee: International Business Machines Corporation

(21) Appl. No.: 12/209,573

(22) Filed: Sep. 12, 2008

(51) Int. Cl. G06F 15/16

(52) U.S. Cl. 709/206

(57) ABSTRACT

A method and system for dynamic e-mail view conversion. An e-mail inbox capable of displaying one or more e-mail messages associated with a particular thread can be dynamically consolidated. Next, the e-mail messages associated with the particular thread can be converted into a forum-like list. Thereafter, varying viewing options are provided with respect to the e-mail inbox in order to optimize user interaction with the e-mail inbox through the use of the forum-like list.

### TECHNICAL FIELD

Embodiments are generally related to data-processing systems and methods. Embodiments also relate in general to the field of computers and similar technologies and in particular to software utilized in this field. In addition, embodiments relate to electronic messaging methods and systems thereof.

### BACKGROUND OF THE INVENTION

Modern computer systems allow for the interchange of data and resources through network environments. Electronic messaging systems, such as e-mail and instant messaging, for example, are widely utilized by individuals and businesses for providing a rapid, low cost means of communication. Certain electronic messaging systems provide a documented record of all communications sent to and from a particular user. While a user can create and send a message independent of any other messages, messages are often part of a message thread.

A message thread is a group of messages that are related to each other, such as when one message is a response to (e.g., a reply to or a forwarding of) another message. Messages in the same message thread typically share various common message data, such as related subjects or common message content. For example, a reply e-mail or voice-mail will often include the contents of the original message as well as additional contents specific to the reply and the subject line of a reply or forwarded e-mail will often include the original subject line along with a relation indicator such as “RE:” or “FW:” respectively.

Many times a group of individuals organized into, for example, a “helpdesk” or support team, may engage in an ongoing conversation with one another by sending e-mail messages related to the topic at hand. In most cases it is expected that each recipient will provide a response to the originator of the message. This can be easily accomplished by selecting a “Reply” function button in the recipient's e-mail application. However, when replies are returned to the originator of a message, the replies are returned individually and are displayed for the originator as separate messages, which are most often separated by other messages that have been transmitter from other parties to the originator.

Various techniques have been employed for organizing and displaying e-mail messages and e-mail threads. FIG. 4, for example, illustrates a sample e-mail inbox 400. The e-mail inbox 400 includes emails sent to a group of people and trigger discussion based on one or more topics amongst one another by replying to the distribution list. The e-mail inbox 400 includes three attributes where the first attribute 410 includes the names of e-mail senders, the second attribute 420 includes the date and time of the mail received and the third attribute 430 includes the subject of the e-mail. The e-mail inbox 400 includes three kinds of topics such as ISSUE1, ISSUE2, and ISSUE3 discussed by a group of people. Reply messages to the issues ISSUE1, ISSUE2, and ISSUE3 are indicated by ‘Re: ISSUE1’, ‘Re: ISSUE2’, and ‘Re: ISSUE3’. Similarly, forwarded messages to the issues can be indicated by ‘Fw: ISSUE1’, ‘Fw: ISSUE2’, and ‘Fw: ISSUE3’. Reply and forward can both happen on the same message and make the issue title as either ‘Re:Fw: ISSUE1’, ‘Re:Fw: ISSUE2’ and ‘Re:Fw: ISSUE3’ or ‘Fw:Re: ISSUE1’, ‘Fw:Re: ISSUE2’ and ‘Fw:Re: ISSUE3’.

FIGS. 5-7 illustrate scenarios that demonstrate the flaw of some existing methods of managing e-mail discussions utilizing threads. FIG. 5A and FIG. 5B illustrate an e-mail inbox 500 comprising e-mail messages related to ISSUE3 and a corresponding mind map 550 respectively. The e-mail inbox 500, for example, demonstrates the flaw of some existing approaches by assuming that someone may reply to a previous e-mail and can create a new thread. In such a condition, existing methods provide solution by creating a mail thread to represent the mail replying thread, as shown in FIG. 5B. Such a solution, however, does not let the user to “know” the latest e-mail replied and the user must still trace each thread to ensure that the issue is being resolved.

FIG. 6A and 6B illustrate an e-mail inbox 600 comprising mails related to ISSUE2 and the corresponding mind map 650 respectively. The example e-mail inbox 600 demonstrates the flaw of some of the existing approaches by assuming that the same mail thread does not necessarily include the same name or even the same content and that the reply and forward status does not always represent the order of reply time. In such a scenario, some existing methods provide a solution by creating a mail thread utilizing the subject. Hence, the user either is forced to create the mail thread utilizing the subject and/or content. In such a situation, the user may not be able to create the whole thread. Such an approach creates two mail threads with respect to user and typically causes more confusion.

FIG. 7A and 7B together illustrate an example e-mail inbox 700 that includes a number of e-mail messages related to ISSUE1 and a corresponding mind map 750, respectively. The e-mail inbox 700 and the mind map 750 illustrate a flaw inherent with existing methods by combining the conditions illustrated in e-mail inbox 500 and 600. Such existing methods involve the originator or user manually searching each e-mail message to trace the entire thread. If the user simply views the latest e-mail message, the user may miss some important details or response because the discussion may be separated into two or more threads or within different e-mail messages. The user can organize all e-mail messages; however, in such a situation, the user may be required to return to view the e-mail inbox and review all e-mail messages in order to determine and connect all e-mail messages from various thread discussions. Also, the e-mail list may break into many lists; hence, the user has to open each e-mail message one by one and it is still possible that some e-mail content may be lost.

Based on the foregoing it is believed that a need exists for an improved method and system for detecting and consolidating a user's e-mail box and converting e-mail messages associated with a thread into a forum-type list format, as described in greater detail herein.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium.

It is another aspect of the present invention to provide for a method, system and computer-usable medium for detecting and consolidating an e-mail box and convert e-mail messages associated with a particular e-mail thread into a forum-type list format.

It is a further aspect of the present invention to provide for a method, system and computer-usable medium for providing improved viewing options with respect to e-mail messages.

The aforementioned aspects and other objectives and advantages can now be achieved as described herein. A computer-implemented method and system for dynamic e-mail view conversion is disclosed. An e-mail inbox capable of displaying one or more e-mail messages (e.g., a group of e-mail messages) associated with a particular thread can be dynamically consolidated. Thereafter, the e-mail messages associated with the particular thread can be converted into a forum-like list. One or more users can then be provided with varying viewing options with respect to the e-mail inbox in order to optimize the user(s) interaction with the e-mail inbox through the use of the forum-like list.

Related e-mail messages can be automatically traced, utilizing header and attribute data, and the e-mail messages then grouped together in a chronological order based on the time it took the user or users to view all replies. Each related e-mail can be tagged with a group ID and the information then stored into a file or repository to create a forum-like view based on defined preferences. Such an approach enables a user to read all replies into threads and view them in a single e-mail in any chronological order. In addition to or in lieu of chronological order, the e-mail messages can be grouped according to other criteria such as, for example, topic, date, recipient, work group, work owner, etc. The forum-like view can be provided as a local view and/or a server view.

Furthermore, the disclosed approach provides more viewing options and allows a user to predefine attributes information to search, find, aggregate, and group related e-mail. The sequences of related e-mail messages can be predicted utilizing a unique ID which can be some combination of timestamp, MAC address, etc. to make the ID unique. The sequence can also be predicted by considering other attributes such as, for example, subject line, recipient name and the order of response within each e-mail section. Several possible prediction techniques may be utilized with respect to the sequences of related e-mail methods. For example, e-mail “sections” or metadata can be analyzed. That is, by extracting metadata from the e-mail message, one can examine the chronological order of the metadata and use this information to make predictions. Another prediction technique involves analyzing the e-mail message subject and/or header to extract some level of information for prediction. Finally, one can utilize tagging in association with a rating table to provide for a prediction capability. A combination of a gradient factor and manual tagging with respect to the e-mail message can assist in prioritizing and more accurately predict a sequence of e-mail message(s).

The disclosed method and/or system stores the essential data in a centralized repository utilizing tagging of the information with respect to each e-mail/thread. The method/system then fetches the centralized repository to perform a query and leverage the result set to create different views that meet the needs of the user including views such as, for example, original, tree, or mind map.

Such an approach essentially changes the mailbox into a forum-like list with one entry for each topic so that every single mail related with a particular topic can be gathered, arranged and viewed in a more systematic manner. The list can be arranged, for example, according to the latest modified time which permits current discussion topics to be displayed and listed at the “top”. The user can view the entire chain of e-mail associated with a thread utilizing such a forum-like list format. The user can quickly sort, change view by tagged attributes, or dynamically merge e-mail messages to return to an original or a standard e-mail view.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention may be embodied;

FIG. 2 illustrates a schematic view of a software system including an operating system, application software, and a user interface for carrying out the present invention;

FIG. 3 depicts a graphical representation of a network of data processing systems in which aspects of the present invention may be implemented;

FIG. 4 illustrates a sample e-mail inbox comprising mails related to different topics;

FIGS. 5A and 5B illustrates an e-mail inbox comprising mails related with ISSUE3 and the corresponding mind map;

FIGS. 6A and 6B illustrates an e-mail inbox comprising mails related with ISSUE2 and the corresponding mind map;

FIGS. 7A and 7B illustrates an e-mail inbox comprising mails related with ISSUE1 and the corresponding mind map;

FIGS. 8A and 8B illustrates an e-mail inbox depicting a forum-like view for three issues and the corresponding mind map, in accordance with a preferred embodiment;

FIG. 9 illustrates a high level flow chart of operations illustrating logical operational steps of a method for dynamic e-mail view conversion, in accordance with a preferred embodiment; and

FIG. 10 illustrates an exemplary block diagram for creating e-mail thread utilizing unique ID, in accordance with a preferred embodiment.

### DETAILED DESCRIPTION

The particular values and configurations discussed in these non-limiting examples can be varied and are cited merely to illustrate at least one embodiment and are not intended to limit the scope of such embodiments.

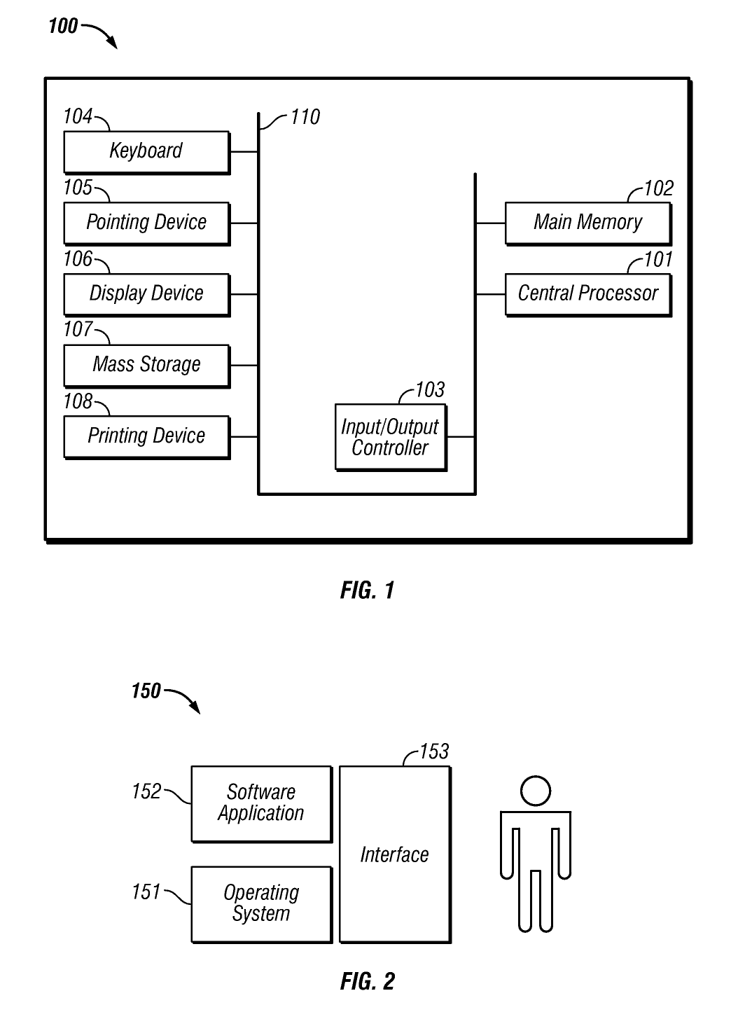

FIGS. 1-3 are provided as exemplary diagrams of data processing environments in which embodiments of the present invention may be implemented. It should be appreciated that FIGS. 1-3 are only exemplary and are not intended to assert or imply any limitation with regard to the environments in which aspects or embodiments of the present invention may be implemented. Many modifications to the depicted environments may be made without departing from the spirit and scope of the present invention.

FIG. 1 illustrates that the present invention may be embodied in the context of a data-processing apparatus 100 comprising a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a printing device 108, may be included in the data-processing apparatus 100 as desired. As illustrated, the various components of the data-processing apparatus 100 communicate through a system bus 110 or similar architecture.

FIG. 2 illustrates a computer software system 150 provided for directing the operation of the data-processing apparatus 100. Software system 150, which is stored in system memory 102 and on disk memory 107, includes a kernel or operating system 151 and a shell or interface 153. One or more application programs, such as application software 152, may be “loaded” (i.e., transferred from storage 107 into memory 102) for execution by the data-processing apparatus 100. The data-processing apparatus 100 receives user commands and data through user interface 153; these inputs may then be acted upon by the data-processing apparatus 100 in accordance with instructions from operating module 151 and/or application module 152.

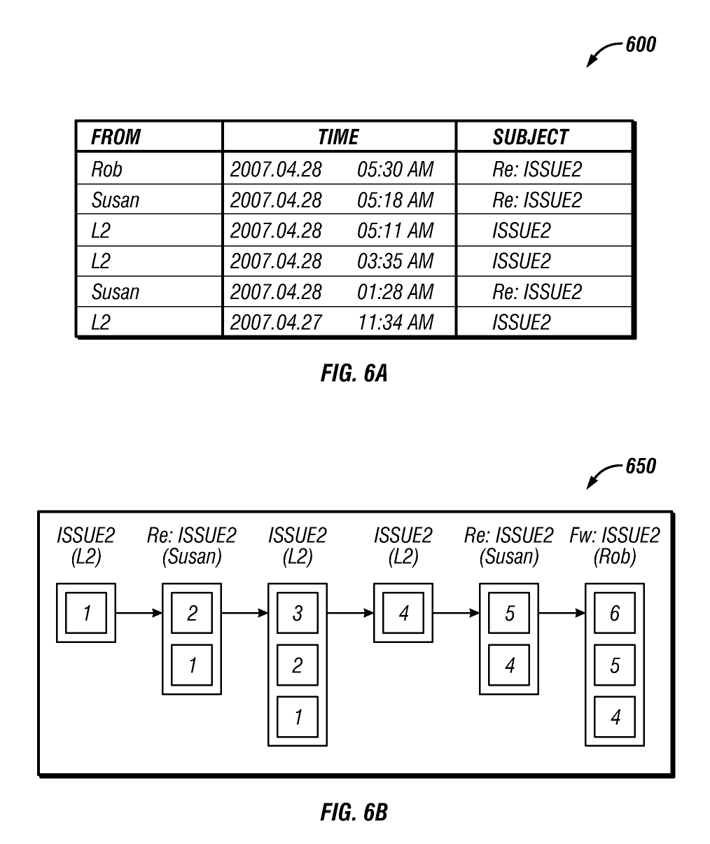

The interface 153, which is preferably a graphical user interface (GUI), also serves to display results, whereupon the user may supply additional inputs or terminate the session. In an embodiment, operating system 151 and interface 153 can be implemented in the context of a “Windows” system. Application module 152, on the other hand, can include instructions, such as the various operations described herein with respect to the various components and modules described herein such as, for example, the method 600 depicted in FIG. 6A.

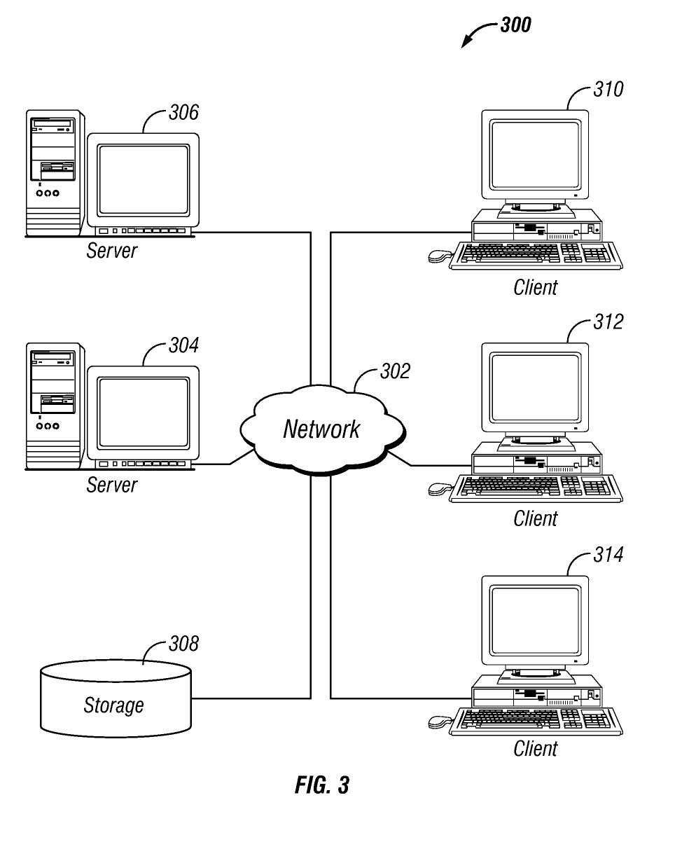

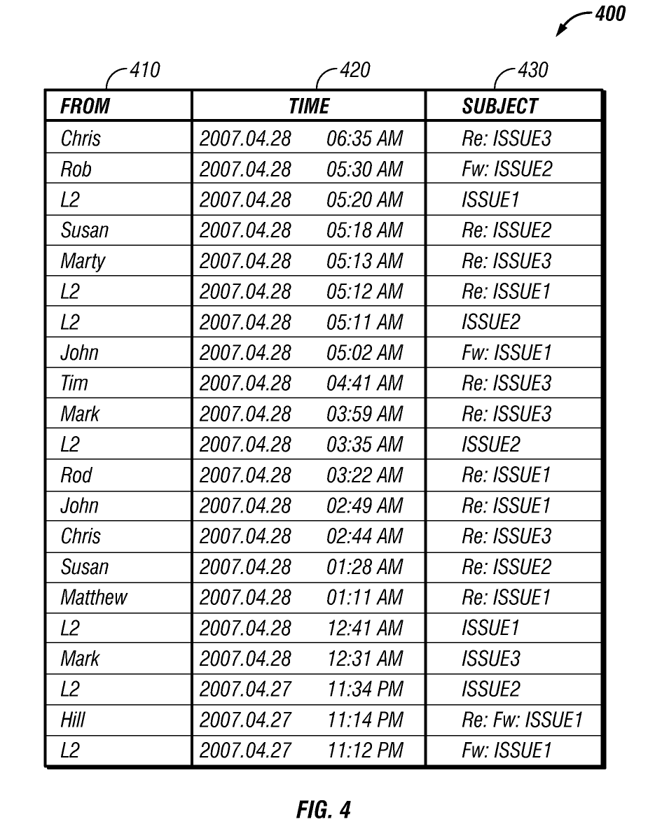

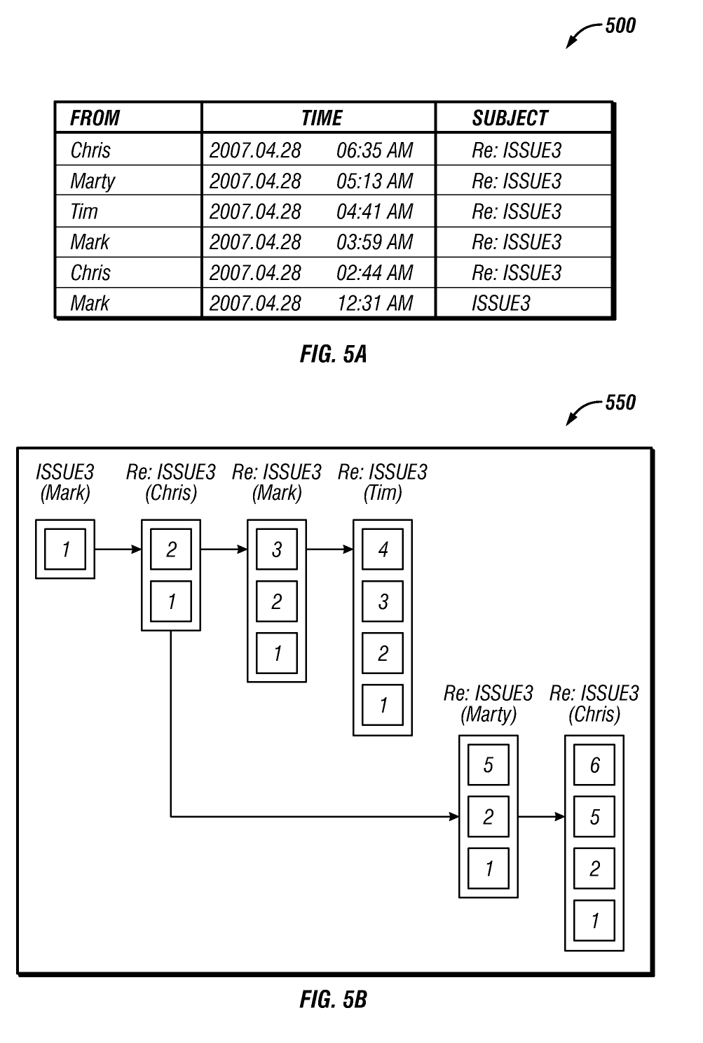

FIG. 3 illustrates a graphical representation of a network of data processing systems in which aspects of the present invention may be implemented. Network data processing system 300 is a network of computers in which embodiments of the present invention may be implemented. Network data processing system 300 contains network 302, which is the medium used to provide communications links between various devices and computers connected together within network data processing apparatus 100. Network 302 may include connections, such as wire, wireless communication links, or fiber optic cables.

In the depicted example, server 304 and server 306 connect to network 302 along with storage unit 308. In addition, clients 310, 312, and 314 connect to network 302. These clients 310, 312, and 314 may be, for example, personal computers or network computers. Data-processing apparatus 100 depicted in FIG. 1 can be, for example, a client such as client 310, 312, and/or 314. Alternatively, data-processing apparatus 100 can be implemented as a server, such as servers 304 and/or 306, depending upon design considerations.

In the depicted example, server 304 provides data, such as boot files, operating system images, and applications to clients 310, 312, and 314. Clients 310, 312, and 314 are clients to server 304 in this example. Network data processing system 300 may include additional servers, clients, and other devices not shown. Specifically, clients may connect to any member of a network of servers which provide equivalent content.

In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 300 also may be implemented as a number of different types of networks such as, for example, an intranet, a local area network (LAN), or a wide area network (WAN). FIG. 1 is intended as an example and not as an architectural limitation for different embodiments of the present invention.

The following description is presented with respect to embodiments of the present invention, which can be embodied in the context of a data-processing system such as data-processing apparatus 100, computer software system 150 and data processing system 300 and network 302 depicted respectively FIGS. 1-3. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

Embodiments of the present invention provide for methods, systems and graphical user interface data structures for detecting and organizing a thread of electronic messages in a manner that allows a user to read the message thread in a logical, succinct manner. As used herein, the term “message thread” refers to a group of electronic messages that are related to each other through a tag or other indicator that electronic messaging clients use to recognize electronic messages as being related. Typically, message threads occur in the context of an electronic “conversation” in which one or more users reply to an originating or root message one or more times. Note that the terms “e-mail” and “e-mail message” as utilized herein, can be utilized interchangeably.

The term “message thread” also contemplates that two or more participants in a conversation may branch off of a main e-mail message thread to create one or more side message threads. The e-mail messages in a message thread may include a variety of content. As used herein, the term “content” refers to any information included in the message body of an electronic message which can include, but is not limited to, text, graphics, images, sound, multimedia content, and the like. The organizational techniques employed herein relate to displaying a message thread which reduces or eliminates the duplication of content within the thread and allows a user to read through the message thread according to the conversational flow of the thread, as opposed to a chronological ordering of the messages.

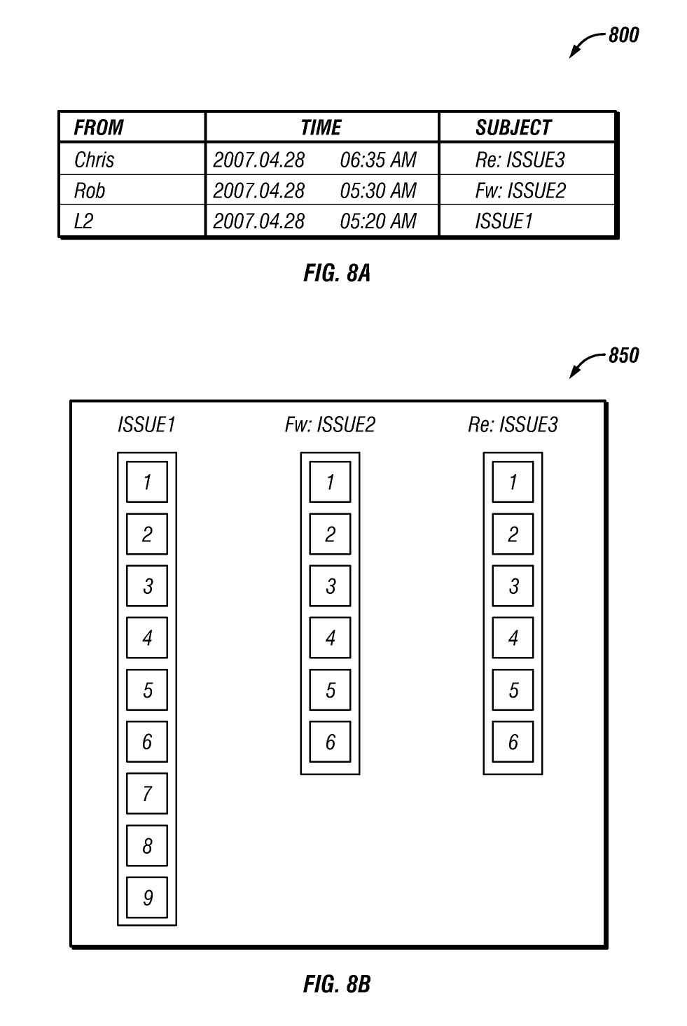

FIGS. 8A and 8B illustrates an e-mail inbox 800 depicting a forum-like list for three issues and the corresponding mind map 850, in accordance with a preferred embodiment. The e-mail inbox 800 includes a forum-like list for ISSUE1, ISSUE2 and ISSUE3. Each issue includes a single entry, which make the list much clearer. The e-mail inbox 800 can include a forum-like list related, for example, to a series of issues regarding a particular subject. Each forum-like list generally includes a root message, a subsequent reply and forward e-mail messages. The forum-like list can be grouped in chronological order based on the latest modified time, which may render some current discussions issues to the top of the list. A user can view all e-mail replies (or posts in forum's term) listed by time after “clicking” into the particular entry. The forum-like list therefore organizes and displays the message thread related to the issue in accordance with the flow of the conversation.

The forum-like list can be configured to provide, for example, a single display of the message thread, which in turn provides the reader/user with the ability to view the content of all e-mail messages in the thread. By providing the content of the messages in a single display, the reader is not required to select multiple messages in order to read an entire e-mail message thread. Instead, the reader can “select” a single e-mail message thread to view, upon which the entire content of the e-mail message thread is displayed to the reader in a single display. Additionally, with such an approach, the user needs not to worry about missing replies in other threads. The latest reply can also be checked and confirmed with respect to, for example, whether the issue is being resolved.

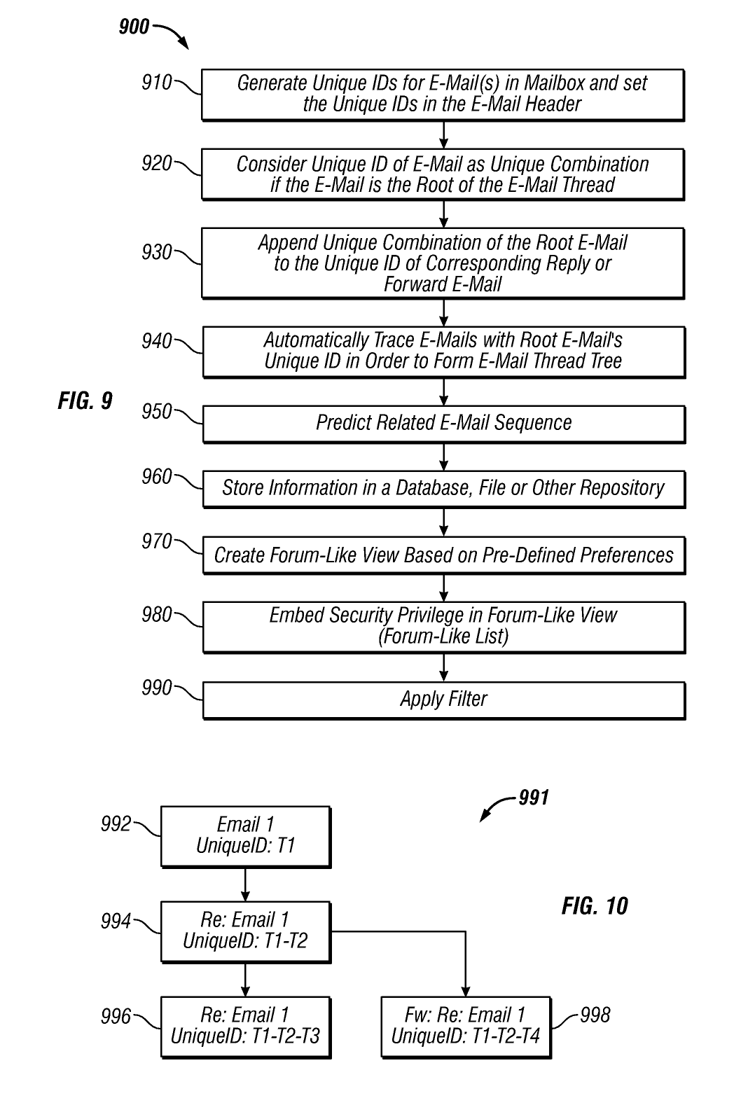

FIG. 9 illustrates a high-level flow chart of operations depicting operational steps of a method 900 for detecting and consolidating an e-mail inbox, in accordance with a preferred embodiment. Note that the method 900 can be implemented in the context of a computer-usable medium containing a program product.

Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as, but not limited to, Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent. Thus, the method 900 described herein can be deployed as process software in the context of a computer system or data-processing system as that depicted in FIGS. 1-3.

Unique IDs for e-mail(s) in mailbox can be generated and can be set in the e-mail header, as depicted at block 910. The unique ID can be provided as, for example, a combination of a timestamp, a MAC address, etc. in order to render the ID unique. The unique ID associated with the e-mail message can be provided in the form of a unique combination of data, if the e-mail is the root of the e-mail thread, as depicted at block 920. The unique combination of the root e-mail can be appended to the unique ID of the corresponding reply or forwarded e-mail, as depicted at block 930. For example, if the e-mail is the root of the e-mail thread (i.e., the e-mail is not a reply or a forward e-mail), then its unique ID will only be the result of a unique combination.

The unique combination can be appended to the unique ID of the reply or forward e-mail and make the whole string as the unique ID of the e-mail, if the e-mail is not the root of the e-mail thread. In that case, the whole tree structure of the e-mail thread and the time of creation of each e-mail message can be traced and can also be known by the timestamp. Thereafter, e-mail messages that are initiated with the root e-mail message's unique ID can be automatically traced in order to form an e-mail thread tree, as depicted at block 940. Note that the operations described herein can be performed automatically by a computer. The actual selection depends on the metadata such as the unique ID described herein, which can be inserted into the e-mail header. The process of selection and composition into an e-mail tree can occur via separate operations. Thereafter, as depicted at block 950, an e-mail sequence can be predicted using the unique ID.

Note that the operation illustrated at block 950 involves utilizing one or more possible techniques for predicting the e-mail sequence. Such a sequence can also be predicted by considering header and attributes information such as, for example, subject line, recipient name and the order of response within each e-mail section and can be tagged with a group ID.

The sequences of related e-mail messages can be predicted utilizing a unique ID which can be some combination of timestamp, MAC address, etc. to make the ID unique. The sequence can also be predicted by considering other attributes such as, for example, subject line, recipient name and the order of response within each e-mail section. Several possible prediction techniques may be utilized with respect to the sequences of related e-mail methods and the operation depicted at block 950. For example, e-mail “sections” or metadata can be analyzed. That is, by extracting metadata from the e-mail message, one can examine the chronological order of the metadata and use this information to make predictions. Another prediction technique involves analyzing the e-mail message subject and/or header to extract some level of information for prediction. Finally, one can utilize tagging in association with a rating table to provide for a prediction capability. A combination of a gradient factor and manual tagging with respect to the e-mail message can assist in prioritizing and more accurately predict a sequence of e-mail message(s).

The information can then be stored into a file or repository, as depicted at block 960. Finally, the forum-like view (i.e., forum-like list) can be created based on the defined preferences, as depicted at block 970. The essential data can be stored in a centralized repository (e.g., database) or simply a file, utilizing tagging of the information in each e-mail/thread to perform a query and leverage the result set to create different views such as, for example, an original view, a tree view, or a mind map. Note that the forum-like view can be provided in the form of a local view or a server view. Following processing of the operation depicted at block 980, an operation to implement security aspects can be implemented. For example, a security privilege such as an ACL (Access Control List) can be embedded into the forum-like view (i.e., the forum-like list) as part of the process of converting to the forum-like view. Such a security privilege can, for example, determine who can access the records, how to limit the forum-like view or list and how to segregate data. Thereafter, as indicated at block 990, a filter may be applied to the forum-like view/list in order to filter list by, for example, topic, work groups, etc. For example, the filter can function to divide the incoming email messages into groups or departments who will handle topic 1, topic 2, etc.

FIG. 10 illustrates a flow chart depicting a method 991 for creating an e-mail thread utilizing the unique ID described earlier, in accordance with an alternative embodiment. FIG. 10 illustrates “e-mail 1” as a root of the e-mail thread with unique ID “T1”, as depicted at block 992. A reply message to “e-mail 1” is indicated by “Re:e-mail 1”. The reply and forward actions can both occur with respect to the same message and can be indicated by, for example, “Fw:Re: e-mail 1”. The unique ID of reply or forward e-mail messages related to “e-mail 1” includes the unique ID of the root e-mail “T1” appended to the unique ID of the corresponding reply or forward e-mail as depicted at blocks 994, 996, and 998. The unique ID “T2” can be appended with respect to “T1” for the reply mail of “e-mail 1” and can be indicated as “T1-T2”, as depicted at block 994. Similarly, for another reply mail to “e-mail 1”, “T3” can be appended to “T1-T2” and the unique ID can be indicated as “T1-T2-T3”, as depicted at block 996. Further, if a reply mail associated with “e-mail 1” is forwarded, T4 can be appended to “T1-T2” and the unique ID can be indicated as “T1-T2-T4”, as depicted at block 998.

E-mail messages related to “e-mail 1” can be selected, for example, utilizing a unique ID “T1” associated with each e-mail message. Hence, any e-mail message with a unique ID starting from “e-mail 1” will possess a unique ID belonging to the e-mail thread related to “e-mail 1”. A node can also be added to the e-mail message to render it into the e-mail thread tree. According to this unique ID, e-mail messages can be automatically selected, which relate to the same issue/topic. An e-mail thread tree can be composed utilizing the unique ID. The time of creation of each e-mail can also be identified by the time stamp included in the unique ID associated with the e-mail message(s). Hence, a related e-mail sequence can be predicted and displayed in a sequential order with respect to the e-mail thread.

Such an approach essentially changes the mailbox into a forum-like list with one entry for an issue so that every single mail related with the same issue can be gathered and arranged and viewed in a more systematic manner (i.e., forum-like view). The list can be arranged according to the latest modified time, which can place current discussion issues at the “top” of the list. The user can then view the entire e-mail chain associated with the thread utilizing the forum-like list format. With this approach, a user can quickly sort, change view via tagged attributes, or dynamically merge e-mail messages to return to an original or standard e-mail view.

Based on the foregoing, it can be appreciated that a number of advantages stem from implementing one or more of the disclosed embodiments. For example, prior art approaches are based mainly on the use of “subject (RE:)” which allows a user to decide if the particular e-mail message is related to another e-mail message. With the disclosed approach, however, the subject is not necessary—(RE). The e-mail message can be forwarded (FW:) or associated with the same subject. With the disclosed approach, one may desire to collect all related e-mail threads into a single forum-like view. This can be achieved by adding some additional header information in each e-mail message such as, for example, a particular serial number (e.g., PMR number).

Additionally, it is important to appreciate that the prior art approaches parse the content to form an email thread. In the scenario discussed herein with respect to FIG. 6B, for example, the 4th e-mail removes all previous e-mail threads and initiates all new content for discussion. Under this situation, the prior art approaches will divide the FIG. 6B scenario into two e-mail threads. With the approach of the disclosed embodiments, the FIG. 6B example will still remain in one piece

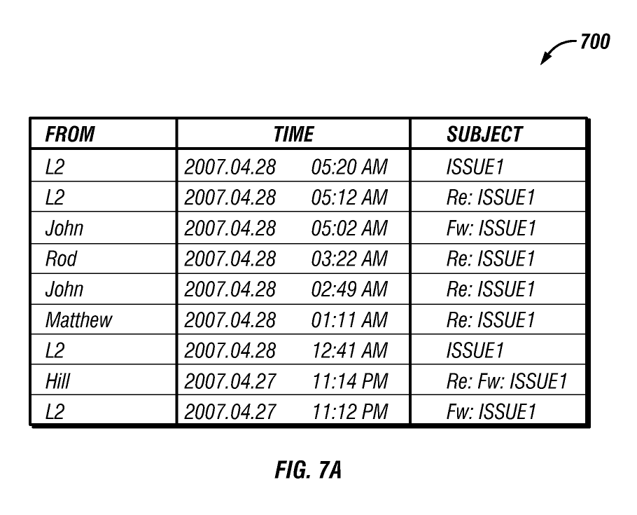

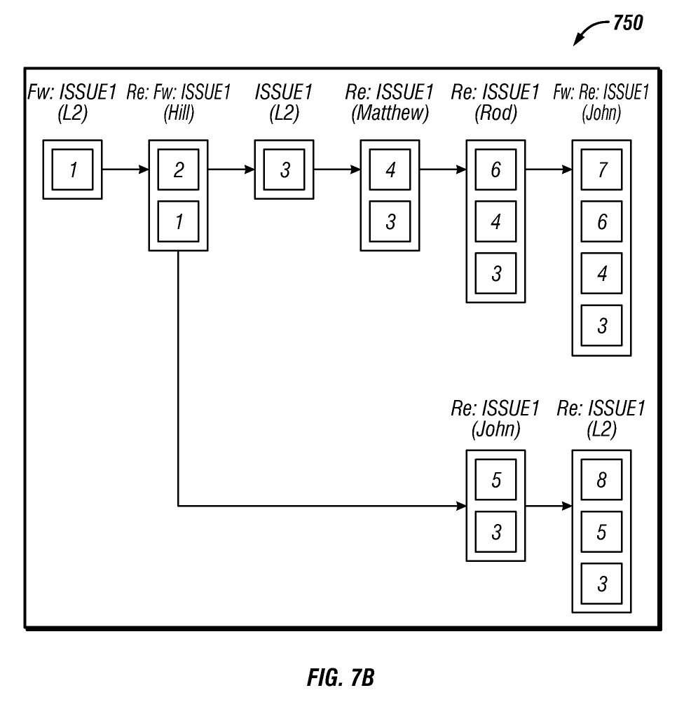

Another advantage of the disclosed embodiments over the prior art approaches, is that such prior art methods list only e-mail messages with respect to the time that the e-mail message was received. However, sometimes the discussion thread may separate into two or more discussions. Then, only a “list by time” can break the connection of each thread. For example, the configuration depicted in FIG. 7B indicates that, from message 2, the discussion can divide into two threads. With the forum-like view approach disclosed herein, however, one can provide a quote section when the message 5 does not answer message 4 (e.g., see FIG. 7B). In this manner, a clearer indication can be provided as to which message is replying to a particular previous message.

The foregoing detailed description therefore describes a computer-implemented method and system for dynamic e-mail view conversion. An e-mail inbox capable of displaying one or more e-mail messages (e.g., a group of e-mail messages) associated with a particular thread can be dynamically consolidated. Thereafter, the e-mail messages associated with the particular thread can be converted into a forum-like list. One or more users can then be provided with varying viewing options with respect to the e-mail inbox in order to optimize the user(s) interaction with the e-mail inbox through the use of the forum-like list.

Related e-mail messages can be automatically traced, utilizing header and attribute data, and the e-mail messages then grouped together in a chronological order based on the time it took the user or users to view all replies. Each related e-mail can be tagged with a group ID and the information then stored into a file or repository to create a forum-like view based on defined preferences. Such an approach enables a user to read all replies into threads and view them in a single e-mail in any chronological order. In addition to or in lieu of chronological order, the e-mail messages can be grouped according to other criteria, such as, for example, topic, date, recipient, work group, work owner, etc. The forum-like view can be provided as a local view and/or a server view.

Furthermore, the disclosed approach provides more viewing options and allows a user to predefine attributes information to search, find, aggregate, and group related e-mail. The disclosed method and/or system also stores the essential data in a centralized repository utilizing tagging of the information with respect to each e-mail/thread. The method/system then fetches the centralized repository to perform a query and leverage the result set to create different views that meet the needs of the user including views such as, for example, original, tree, or mind map.

Such an approach essentially changes the mailbox into a forum-like list with one entry for each topic so that every single mail related with a particular topic can be gathered, arranged and viewed in a more systematic manner. The list can be arranged, for example, according to the latest modified time, which permits current discussion topics to be displayed and listed at the “top”. The user can view the entire chain of e-mail associated with a thread utilizing such a forum-like list format. The user can quickly sort, change view by tagged attributes, or dynamically merge e-mail messages to return to an original or a standard e-mail view.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for dynamic e-mail view conversion, comprising:
dynamically consolidating an e-mail inbox capable of displaying a plurality of e-mail messages associated with a particular thread;
converting said plurality of e-mail messages associated with said particular thread into a forum-like list; and
thereafter providing varying viewing options with respect to said e-mail inbox in order to optimize a user interaction with said e-mail inbox through the use of said forum-like list.

2. The method of claim 1 further comprising configuring said forum-like list to comprise a single display with respect to a particular topic.

3. The method of claim 1 further comprising grouping said plurality of e-mail messages in a chronological order based on a particular time.

4. The method of claim 1 further comprising pre-defining a plurality of attribute data in order to thereafter search, aggregate and group said plurality of e-mail messages and thereby optimize a user interaction with an e-mail application supporting said e-mail inbox and said forum-like list.

5. The method of claim 1 further comprising defining particular criteria for consolidating said plurality e-mail messages with respect to said forum-like list.

6. The method of claim 5 wherein said particular criteria include at least one of the following criteria: chronological order, subject matter, time, recipient, work group and work owner.

7. The method of claim 1 further comprising permitting a user who originated a particular e-mail message among said plurality of e-mail messages to designate and grant a particular level of access to another user with respect to said forum-like list.

8. The method of claim 1 further comprising:
consolidating said plurality of e-mail messages in said forum-like list in response to a particular input.

9. The method of claim 1 further comprising:
allowing direct access to said forum-like list and said tagged e-mail messages among said plurality of e-mail messages.

10. The method of claim 1 wherein dynamically consolidating said e-mail inbox capable of displaying said plurality of e-mail messages associated with said particular thread, further comprises:
tracing said plurality of e-mail messages with respect to a particular topic utilizing header and attribute data associated with at least one e-mail message among said plurality of e-mail messages.

11. The method of claim 1 further comprising providing a single display with respect to said forum-like list that allows said at least one user to view a particular content of e-mail messages among said plurality of e-mail messages related to a particular topic with respect to a particular root e-mail message and at least one reply e-mail message among said plurality of e-mail messages.

12. The method of claim 1 wherein converting said plurality of e-mail messages associated with said particular thread into a forum-like list, further comprises embedding a security privilege into said forum-like list that restricts access to said forum-like list based on predetermined criteria.

13. The method of claim 1 further comprising providing said forum-like list as a forum-like view, wherein said forum-like view comprises at least one of the following: a local view and a server view.

14. The method of claim 1 further comprising analyzing data contained within at least one e-mail message among said plurality of e-mail messages in order to predict a sequence of e-mail messages associated with said plurality of e-mail messages.

15. A method for dynamic e-mail view conversion, comprising:
dynamically consolidating an e-mail inbox capable of displaying a plurality of e-mail messages associated with a particular thread;
converting said plurality of e-mail messages associated with said particular thread into a forum-like list;
providing varying viewing options with respect to said e-mail inbox in order to optimize a user interaction with said e-mail inbox through the use of said forum-like list; and
analyzing information contained within at least one e-mail message among said plurality of e-mail messages in order to predict a sequence of e-mail messages associated with said plurality of e-mail messages.

16. A system for dynamic e-mail view conversion, said system comprising:
a processor;
a data bus coupled to said processor; and
a computer-usable medium embodying computer code, said computer-usable medium being coupled to said data bus, said computer program code comprising instructions executable by said processor and configured for:
dynamically consolidating an e-mail inbox capable of displaying a plurality of e-mail messages associated with a particular thread;
converting said plurality of e-mail messages associated with said particular thread into a forum-like list; and
thereafter providing varying viewing options with respect to said e-mail inbox in order to optimize a user interaction with said e-mail inbox through the use of said forum-like list.

17. The system of claim 16 wherein said instructions are further configured for modifying said forum-like list to comprise a single display with respect to a particular topic.

18. The system of claim 16 wherein said instructions are further configured for grouping said plurality of e-mail messages in a chronological order based on a particular time.

19. The system of claim 16 wherein said instructions are further configured for pre-defining a plurality of attribute data in order to thereafter search, aggregate and group said plurality of e-mail messages and thereby optimize a user interaction with an e-mail application supporting said e-mail inbox and said forum-like list.

20. The system of claim 16 wherein said instructions are further configured for defining particular criteria for consolidating said plurality e-mail messages with respect to said forum-like list.
